(19) United States
(12) Patent Application Publication
(10) Pub. No.: US 2013/0132433 A1
(43) Pub. Date: May 23, 2013

(54) METHOD AND SYSTEM FOR CATEGORIZING WEB-SEARCH QUERIES IN SEMANTICALLY COHERENT TOPICS

(71) Applicants: Umut Ozertem, Sunnyvale, CA (US); Debora Donato, San Francisco, CA (US); Luca Aiello, Torino (IT)

(72) Inventors: Umut Ozertem, Sunnyvale, CA (US); Debora Donato, San Francisco, CA (US); Luca Aiello, Torino (IT)

(73) Assignee: Yahoo! Inc., Sunnyvale, CA (US)

(21) Appl. No.: 13/301,786

(22) Filed: Nov. 22, 2011

(51) Int. Cl. G06F 17/30

(52) U.S. Cl. 707/771; 707/E17.014

(57) ABSTRACT

A method and system for categorizing web-search queries in semantically coherent topics. The method includes receiving plurality of web-search queries from one or more users and storing the plurality of web-search queries in a query log. The method further includes processing the plurality of web-search queries for topic generation by generating plurality of missions from the query log and merging together one or more missions belonging to a similar topic. Further, the method includes determining topical user profile of a user by matching each mission of the user with one or more relevant topics, and detecting user activity of the user from random user activity. Moreover, the method includes naming one or more semantically coherent topics using a set of common concept terms extracted from the plurality of web-search queries. The system includes one or more electronic devices, a communication interface, a memory, and a processor.

### TECHNICAL FIELD

Embodiments of the disclosure relate to the field of categorizing web-search queries in semantically coherent topics.

### BACKGROUND

Methodologies for improving web search are being extensively studied. In a vast majority of cases, such methodologies are query-centric, where only a web-search query is used to understand intent of a user and to provide relevant web search results. Existing techniques classify web-search queries according to a predefined set of categories. However, such techniques, for example query clustering, usually rely on lexical and click through data, while disregarding information originating from user actions in submitting the web-search queries. Further, user-models built on such techniques are usually not successful due to less personalization. Users also have to issue multiple and different queries to reach similar information which is time-consuming.

In the light of the foregoing discussion, there is a need for a method and system for an efficient technique to categorize web-search queries in semantically coherent topics.

### SUMMARY

The above-mentioned needs are met by a method, a computer program product and a system for categorizing web-search queries in semantically coherent topics.

An example of a method of categorizing web-search queries in semantically coherent topics includes receiving a plurality of web-search queries from one or more users. The method also includes storing the plurality of web-search queries in a query log. The method further includes processing the plurality of web-search queries for topic generation by generating a plurality of missions from the query log and merging together one or more missions belonging to a similar topic. Further, the method includes determining a topical user profile of a user by matching each mission of the user with one or more relevant topics, and detecting user activity of the user from random user activity. Moreover, the method includes naming one or more semantically coherent topics using a set of common concept terms extracted from the plurality of web-search queries.

An example of a computer program product stored on a non-transitory computer-readable medium that when executed by a processor, performs a method of categorizing web-search queries in semantically coherent topics includes receiving a plurality of web-search queries from one or more users. The computer program product also includes storing the plurality of web-search queries in a query log. The computer program product further includes processing the plurality of web-search queries for topic generation by generating a plurality of missions from the query log and merging together one or more missions belonging to a similar topic. Further, the computer program product includes determining a topical user profile of a user by matching each mission of the user with one or more relevant topics, and detecting user activity of the user from random user activity. Moreover, the computer program product includes naming one or more semantically coherent topics using a set of common concept terms extracted from the plurality of web-search queries.

An example of a system for categorizing web-search queries in semantically coherent topics includes one or more electronic devices. The system also includes a communication interface in electronic communication with the one or more electronic devices. The system further includes a memory that stores instructions. Further, the system includes a processor responsive to the instructions to receive a plurality of web-search queries from one or more users. The processor is also responsive to the instructions to store the plurality of web-search queries in a query log. The processor is further responsive to the instructions to process the plurality of web-search queries for topic generation by generating a plurality of missions from the query log and merging together one or more missions belonging to a similar topic. Further, the processor is responsive to the instructions to determine a topical user profile of a user by matching each mission of the user with one or more relevant topics, and detecting user activity of the user from random user activity. Moreover, the processor is responsive to the instructions to name one or more semantically coherent topics using a set of common concept terms extracted from the plurality of web-search queries.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment; and

FIG. 3 is a flowchart illustrating a method of categorizing web-search queries in semantically coherent topics, in accordance with one embodiment.

### DETAILED DESCRIPTION OF THE EMBODIMENTS

The above-mentioned needs are met by a method, computer program product and system for categorizing web-search queries in semantically coherent topics. The following detailed description is intended to provide example implementations to one of ordinary skill in the art, and is not intended to limit the invention to the explicit disclosure, as one or ordinary skill in the art will understand that variations can be substituted that are within the scope of the invention as described.

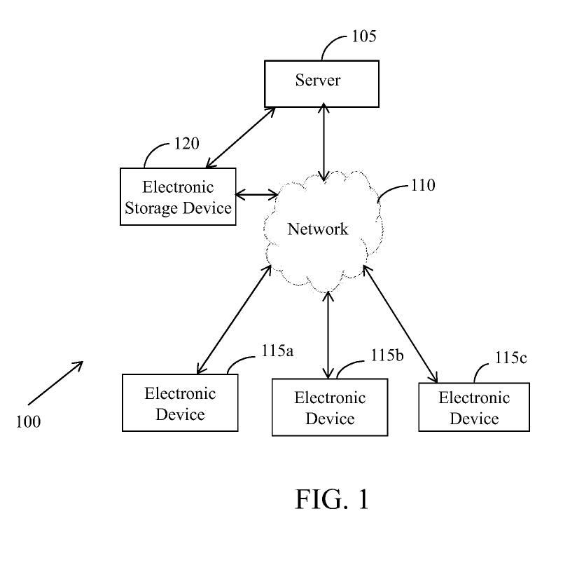

FIG. 1 is a block diagram of an environment 100, in accordance with which various embodiments can be implemented.

The environment 100 includes a server 105 connected to a network 110. The environment 100 further includes one or more electronic devices, for example an electronic device 115a, an electronic device 115b and an electronic device 115c, which can communicate with each other through the network 110. Examples of the electronic devices include, but are not limited to, computers, mobile devices, laptops, palmtops, hand held devices, telecommunication devices, and personal digital assistants (PDAs).

The electronic devices can also communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example a plurality of web-search queries in a query log, one or more semantically coherent topics, and a set of common concept terms.

In some embodiments, different electronic storage devices are used for storing the information.

A user of an electronic device, for example the electronic device 115a, can access a web search engine, for example Yahoo!® Search, on a web page via the electronic device 115a. The user enters one or more web-search queries, via the network 110, through the web search engine and the web-search queries are processed for topic generation by the server 105, for example the Yahoo!® server. The electronic storage device 120 can store the web-search queries in the query log. The server 105 generates a plurality of missions from the query log and merges together one or more missions belonging to a similar topic. The server 105 determines a topical user profile of the user. The server 105 further names one or more semantically coherent topics using a set of common concept terms extracted from the plurality of web-search queries.

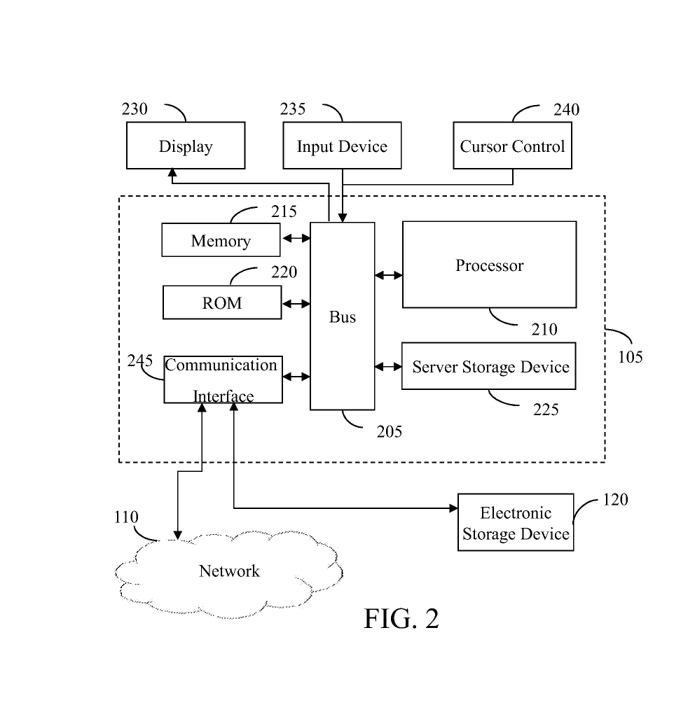

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A server storage device 225, for example a magnetic disk or optical disk, is provided and coupled to the bus 205 for storing information, for example a plurality of web-search queries in a query log, one or more semantically coherent topics, and a set of common concept terms.

The server 105 can be coupled via the bus 205 to a display 230, for example a cathode ray tube (CRT), and liquid crystal display (LCD) for displaying a web search engine and web-search results to the user. An input device 235, including alphanumeric and other keys, is coupled to bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of server 105 for implementing the techniques described herein. In some embodiments, the techniques are performed by the server 105 in response to the processor 210 executing instructions included in the memory 215. Such instructions can be read into the memory 215 from another machine-readable medium, for example the server storage device 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the server storage device 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the server storage device 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the web-search queries in the query log, the semantically coherent topics, and the set of common concept terms.

In some embodiments, the server 105, for example a Yahoo!® server, receives the web-search queries from one or more users and stores the web-search queries in the query log. The server 105 then processes the web-search queries for topic generation by generating a plurality of missions from the query log and merging together one or more missions belonging to a similar topic. The server 105 determines a topical user profile of a user by matching each mission of the user with one or more relevant topics, and detecting user activity of the user from random user activity. The server 105 further names the semantically coherent topics using the set of common concept terms extracted from the web-search queries.

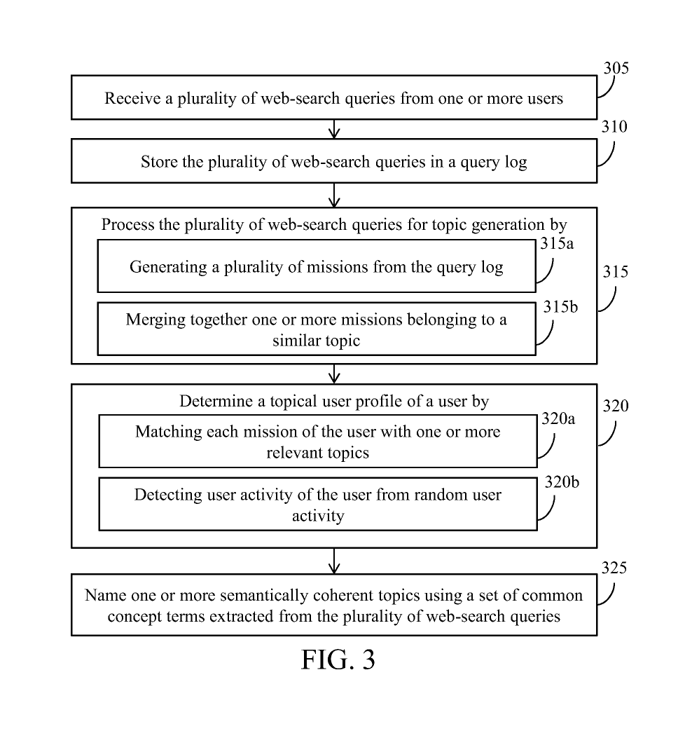

FIG. 3 is a flowchart illustrating a method of categorizing web-search queries in semantically coherent topics, in accordance with one embodiment. The semantically coherent topics are hereinafter referred to as topics.

At step 305, a plurality of web-search queries is received from one or more users. Each user enters one or more web-search queries in a web search engine, for example Yahoo!® Search, on a web browser, for example Yahoo!®, via an electronic device, for example the electronic device 115a. The web-search queries are received by a server, for example the server 105. In one example, the server can be a content server of Yahoo!®.

At step 310, the web-search queries are stored in a query log. The query log is included in the server, for example the server 105. The web-search queries are clustered based on intent of a user and subsequently stored in the query log.

In some embodiments, the query log can be defined as a set of tuples including a submitted web-search query, an anonymous user identifier, a time when user action occured, a set of documents returned by the web search engine, and a set of clicked documents.

At step 315, the web-search queries are processed for topic generation.

At step 315a, a plurality of missions is generated from the query log. Example of one technique for generating the missions is described in a U.S. patent application Ser. No. 12/344,138 entitled, “Segmentation of Interleaved Query Missions into Query Chains” having publication number US20100161643, filed on Dec. 24, 2008 and assigned to Yahoo! Inc., which is incorporated herein by reference in its entirety. Mission boundaries are detected in a web-search query sequence of each user by a mission similarity classifier. In some embodiments, the missions are generated using a segmentation model that is automatically learned.

In some embodiments, a mission can be defined as a related set of information needs, resulting in one or more goals. In one example, purchasing a vacuum cleaner is a mission that represents an intent that the user wants to satisfy. Three steps, namely searching for vacuum cleaner models, comparison of vacuum cleaner models and comparison of vacuum cleaner sellers, are three sub-tasks (or goals) in the mission. The web-search queries in the mission have a high topical coherence, which indicates that the web-search queries are issued with a main common objective. It has been observed that search activities that take place in complex domains, for example travel or health, often require several queries before complex user intents are completely satisfied.

The mission and a topic are correlated to each other. Sequences of web-search queries that coherently express a well-defined user intent usually have high topical coherence. Hence, the missions can be used as fundamental building blocks for topics. The missions can also be merged together if semantically similar.

### Detection of Missions

To partition user activity into the missions, a machine learning method is used, for example the machine learning method described in publication entitled, “The Query-Flow Graph: Model and applications” by Paolo Boldi, Francesco Bonchi, Carlos Castillo, Debora Donato, Aristides Gionis, Sebastiano Vigna, published in CIKM '08: Proceeding of the 17th ACM conference on Information and Knowledge Management, Pages: 609-618, Year of Publication: 2008, which is incorporated herein by reference in its entirety. The machine learning method is able to detect the mission boundaries of the mission by analyzing a live stream of user actions performed by the user on the web search engine. The machine learning method relies on a classifier that works at level of web-search query pairs. Given a set of features extracted from a pair of consecutive query log tuples, tuple1 and tuple2 generated by one user, the classifier indicates whether tuple2 is coherent with tuple1, from a topical perspective. When two web-search queries are found to be incoherent, then a mission boundary is placed, such that the query log is partitioned into the missions including one or more tuples.

The set of features used for mission segmentation are based on three different domains, namely textual features, session features, and time-related features. The textual features include different types of lexical similarity between two web-search queries. The session features measure several aspects of click activity of the user in a time period between the two web-search queries and in an overall session. The time-related features are based on an inter-event time distance for some representative user actions. Using the set of features together, the mission similarity classifier is able to reach around 93% accuracy in detecting the mission boundaries on real user data streams. However, the missions identified by the machine learning method, need to be submitted by one user and have to be consecutive in time thereby generating short-lived missions. Hence, topical coherence constraints need to be imposed on the missions.

Merging Missions

Based on mission boundary detection, it is possible to segment the user activity of every query log into the missions. The topical coherence of the web-search queries inside one mission can be used to generalize method used for mission boundary detection to topic extraction. For such a purpose, a topic similarity classifier, trained based on data generated by the mission similarity classifier, is used to decide whether two web-search query sets belong to a similar topic.

Positive examples are automatically built by splitting consecutive web-search queries belonging to one mission in two groups and considering the two groups as separate missions or sub-missions belonging to the similar topic. Negative examples are formed by sets of web-search queries belonging to consecutive missions of one user, as the web-search queries are topically unrelated due to being separated by a boundary placed by the mission similarity classifier. The topic similarity classifier then provides a topical similarity function such that, given two web-search query sets in input, returns a confidence score in [0, 1] measuring topical relatedness of the two web-search query sets. In some embodiments, the topic similarity function can be used iteratively to extract topics from the data generated by a mission boundary detector.

Features given as input to the topic similarity classifier are aggregated values over features computed from each web-search query pair across two missions. Given a pair of missions, positive or negative, each web-search query pair is taken into account. Subsequently, values of each feature are aggregated over each web-search query pair yielding four scores representing average, standard deviation, minimum and maximum values for each feature. For each web-search query pair, the features from three different categories are extracted:
Lexical features—Often, similarity between text of different web-search queries denote a close semantic relation, for example paris cheap travel and travelling to paris. The topic similarity classifier is hence trained using several lexical features, for example length of common prefix and suffix, size of intersection, edit distance, and similarity measures computed at word and character 3-grams level.
Behavioral features—Behavior of the users during the user activity provides information on semantic relatedness of the web-search queries. For example, if the user submits two web-search queries in close succession, it is likely that the two web-search queries are related to each other, based on an assumption that the user activity is high and the web-search queries submitted in close succession are meant to accomplish one task. However, since user behavior is heterogeneous, it is necessary to aggregate behavioral information from several user sessions. Average values of the behavioral features are determined from the query log of over a year for each web-search query pair. An average time and average number of clicks between two web-search queries are examples of the behavioral features.
Search result features—Web-search results returned for a pair of topically-related web-search queries will also be topically related to some extent. Hence, a set of web-search result-related features, for example intersection between web-search result sets and similarity between vectors of frequent words from a given content dictionary appearing in N top web-search results, is considered.

In some embodiments, the topic generation is performed using a topic extraction algorithm, for example a greedy agglomerative topic extraction (GATE) algorithm. Choice of a relevant partitioning criterion is necessary for outcome of the GATE algorithm. To maximize a number of topics merged at each iteration, partitions need to include topics that are likely to be combined than randomly selected topics, which can be achieved by putting in one partition topics that share some of the features given in input to the topic similarity. For example, the topics can be partitioned on a common character-level 3-gram that appears in the web-search query sets, given that the topics with some lexical similarity are likely to be merged than random topics. The partitioning criterion can also possibly change at each iteration.

In some embodiments, if a first iteration of the GATE algorithm is run keeping the missions of different users in different partitions, then resulting agglomeration produces a minimal group of topically coherent mission sets defined as supermissions. The supermissions allow to define a compact profile of user activity on a topical basis.

At step 315b, one or more missions, or a pair of query sets, belonging to a similar topic are merged together. The missions can be merged together by a topic similarity classifier and based on a high topical similarity score.

The missions are characterized by a main objective and one or more sub-tasks related to the objective itself. In one example, a mission devoted to organize a trip, has the travel itself as the main objective and a number of functional sub-tasks, for example booking the flight, reserving the hotel, and finding a guided tour. Travel missions generated by different users are characterized by a main objective regardless chosen destination, a temporal order in which the sub-tasks are issued or even recreational activities booked. Hence, the missions of the users devoted to organize a travel can be seen as part of the similar topic or cognitive content. The missions within the similar cognitive content are meant to fulfill one or more intents related to such content.

In some embodiments, a topic can be defined as an aggregation of the missions with the similar cognitive content generated over time across different users.

The topic similarity classifier is trained using output of the mission boundary detector. In a training phase, positive examples are derived by artificially splitting the missions and considering two splits as two distinct missions belonging to the similar topic, negative examples are consecutive missions in a web-search query stream. According to mission similarity behavior, two parts of a single mission are topic-coherent as every mission expresses a single intent, while the consecutive missions express different intents. When applied to two web-search query sets, the topic similarity classifier outputs the confidence score that can be interpreted as a level of topical similarity.

The missions are further merged iteratively into wider supermissions or topics. In each iteration, the topic similarity classifier is applied to pairs of missions or topics that can be possibly merged for high topical similarity scores. To lower computational complexity, the topic similarity classifier is applied just inside small partitions of a current mission or topic set. A partition criterion can change at any iteration, for example a user-based iteration or a word-based iteration. The GATE algorithm stops when ratio between number of topics in two subsequent iterations is over a given threshold.

At step 320, a topical user profile of the user is determined.

At step 320a, each mission of the user is matched with one or more relevant topics. Each match is weighted using a topical similarity score that the topic similarity classifier outputs. A normalized aggregation over matches of the missions leads to a normalized weighted vector of topics, which is the topical user profile.

At step 320b, user activity of the user is detected from random user activity. The user activity is detected by matching a sequence of missions on the topical user profile by applying the topic similarity classifier between each mission and topic in the topical user profile.

Any sequence of missions can be matched on the topical user profile by applying the topical similarity classifier between each mission and every topic in the topical user profile, weighting a result using probability of a considered topic in the topical user profile, and then aggregating the result over the missions in the sequence of missions. A match results in a weighted vector over the topics of the topical user profile. Different match vectors can be compared to determine a best match for considered topical user profile. Comparison is made by looking at top N values of each match vector and selecting one with highest number of scores above other vectors. The user activity of a profiled user can hence be detected from the random user activity.

In some embodiments, a practical way to use the topics extracted from the query log is to profile users on a topical basis. Each user can be described by a set of topics that match submitted queries. To build the topical user profile of the user, the topical similarity function is applied between the missions and every topic that includes at least one query from the mission and subsequently selecting a best match. Given best match scores, the topical user profile can be defined as a weighted vector over the topics matching associated missions. For a compact user representation, supermissions can be used instead.

The topical user profile can be used not only to detect the topics relevant to the user, but also to predict future search goals of the user. To check such a potential prediction, a test is performed to determine whether the topical user profile matches future missions of the user more than random missions from other users. The match between the mission and the topical user profile is performed by computing the topical similarity function between the mission and every topic in the topical user profile, and scaling the resulting scores by weights of corresponding topics in the topical user profile, which yields a vector of match scores over the profile topics. The match vector can be generalized to sequences of missions by averaging elements of the vectors across the missions.

At step 325, one or more topics are named using a set of common concept terms extracted from the web-search queries.

After determining the topical user profile of each user, each user identifier can be represented as a mixture of N topics, each topic being identified by a unique numerical identifier.

Such a representation is useful to predict what future search sessions might be about, however it is not directly useful for other Yahoo! properties, for example content or advertising, where the topical user profile might be useful. Hence, the topics need to be named using the set of common concept terms extracted from the web-search queries.

In some embodiments, the set of common concept terms are identified using a scoring method. The scoring method determines a high score of a common concept term if the term has a high frequency of appearance in multiple web-search queries within the topic and if the term does not appear in many topics.

After naming the topics, the topical user profile becomes a weighted combination of the common concept terms, which is directly useful for advertising and content teams to match relevant content that contains such common concept terms.

The present disclosure categorizes web-search queries in semantically coherent topics by taking intent of a user into account for topic generation. Hence, if a web-search query has multiple intents in different missions, the web-search query can appear in multiple topics. A user-level topic distribution has direct applications in user profiling and personalization in Yahoo! Search and other websites. Topic distributions that are generated are useful for user profiling, identifying similar users, and determining the topics of future search sessions. The naming of the topics makes the topic distributions directly useful for profiling projects in other websites as well.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of categorizing web-search queries in semantically coherent topics, the method comprising:
receiving a plurality of web-search queries from one or more users;
storing the plurality of web-search queries in a query log;
processing the plurality of web-search queries for topic generation by
generating a plurality of missions from the query log; and
merging together one or more missions belonging to a similar topic;
determining a topical user profile of a user by
matching each mission of the user with one or more relevant topics; and
detecting user activity of the user from random user activity; and
naming one or more semantically coherent topics using a set of common concept terms extracted from the plurality of web-search queries.

2. The method as claimed in claim 1, wherein storing the plurality of web-search queries comprises
clustering the plurality of web-search queries based on intent of the user.

3. The method as claimed in claim 1, wherein generating the plurality of missions comprises
detecting mission boundaries in a web-search query sequence of each user by a mission similarity classifier.

4. The method as claimed in claim 1, wherein the one or more missions belonging to the similar topic are merged together by a topic similarity classifier.

5. The method as claimed in claim 1, wherein the one or more missions belonging to the similar topic are merged together based on a high topical similarity score.

6. The method as claimed in claim 1, wherein matching each mission of the user with the relevant topic comprises
weighting each match using a topical similarity score.

7. The method as claimed in claim 1, wherein detecting the user activity of the user comprises
matching a sequence of missions on the topical user profile by applying the topic similarity classifier between each mission and topic in the topical user profile.

8. The method as claimed in claim 1 and further comprising
identifying the set of common concept terms using a scoring method.

9. A computer program product stored on a non-transitory computer-readable medium that when executed by a processor, performs a method of categorizing web-search queries in semantically coherent topics, comprising:
receiving a plurality of web-search queries from one or more users;
storing the plurality of web-search queries in a query log;
processing the plurality of web-search queries for topic generation by
generating a plurality of missions from the query log; and
merging together one or more missions belonging to a similar topic;
determining a topical user profile of a user by
matching each mission of the user with one or more relevant topics; and
detecting user activity of the user from random user activity; and
naming one or more semantically coherent topics using a set of common concept terms extracted from the plurality of web-search queries.

10. The computer program product as claimed in claim 9, wherein storing the plurality of web-search queries comprises
clustering the plurality of web-search queries based on intent of the user.

11. The computer program product as claimed in claim 9, wherein generating the plurality of missions comprises
detecting mission boundaries in a web-search query sequence of each user by a mission similarity classifier.

12. The computer program product as claimed in claim 9, wherein the one or more missions belonging to the similar topic are merged together by a topic similarity classifier.

13. The computer program product as claimed in claim 9, wherein the one or more missions belonging to the similar topic are merged together based on a high topical similarity score.

14. The computer program product as claimed in claim 9, wherein matching each mission of the user with the relevant topic comprises
weighting each match using a topical similarity score.

15. The computer program product as claimed in claim 9, wherein detecting the user activity of the user comprises
matching a sequence of missions on the topical user profile by applying the topic similarity classifier between each mission and topic in the topical user profile.

16. The computer program product as claimed in claim 9 and further comprising
identifying the set of common concept terms using a scoring method.

17. A system for categorizing web-search queries in semantically coherent topics, the system comprising:
one or more electronic devices;
a communication interface in electronic communication with the one or more electronic devices;
a memory that stores instructions; and
a processor responsive to the instructions to
receive a plurality of web-search queries from one or more users;
store the plurality of web-search queries in a query log;
process the plurality of web-search queries for topic generation by
generating a plurality of missions from the query log; and
merging together one or more missions belonging to a similar topic;
determine a topical user profile of a user by
matching each mission of the user with one or more relevant topics; and
detecting user activity of the user from random user activity; and
name one or more semantically coherent topics using a set of common concept terms extracted from the plurality of web-search queries.

18. The system as claimed in claim 17 and further comprising
an electronic storage device that stores the plurality of web-search queries in the query log, the one or more semantically coherent topics, and the set of common concept terms.

19. The system as claimed in claim 17, wherein the processor is further responsive to the instructions to
identify the set of common concept terms using a scoring method.

20. The system as claimed in claim 17, wherein the processor is further responsive to the instructions to
detect mission boundaries in a web-search query sequence of each user by a mission similarity classifier; and
merge together the one or more missions belonging to the similar topic by a topic similarity classifier.
